(19) United States
(12) Patent Application Publication
(10) Pub. No.: US 2007/0150855 A1
(43) Pub. Date: Jun. 28, 2007

(54) Method and system of developing a software with utilizing extended metadata of component under component-based development environment

(76) Inventor: An Mo Jeong, Seoul (KR)

Correspondence Address: LOWE HAUPTMAN BERNER, LLP, 1700 DIAGONAL ROAD, SUITE 300, ALEXANDRIA, VA, 22314, US

(21) Appl. No.: 10/546,805

(22) PCT Filed: May 12, 2004
(86) PCT No.: PCT/KR04/01099

§ 371 Date: Jul. 31, 2006

(30) Foreign Application Priority Data
May 12, 2003 (KR) 10-2003-0029704
May 12, 2004 (KR) 10-2004-0033449

(51) Int. Cl. G06F 9/44

(52) U.S. Cl. 717/106

(57) ABSTRACT

The present invention relates a component-based software development technology, and more particularly to so-called the Active Binding Technology which allows the software development by assembling the components released under a component-based development platform. The present invention discloses a new type of component with extended metadata, which includes the interface information about the dependent contract of a component thereby enabling a program developer to assemble the components in a multi-layered structure and/or on the distributed network.

### TECHNICAL FIELD

The present invention relates to a component-based software development (CBSD) technology, and more particularly, to a software development method by assembling a plurality of components which are supplied in a binary code form to the market after being independently developed to have a particular interface by unrelated developers, to a new component metadata format, and to a development tool and a development environment for embodying the format.

### BACKGROUND ART

The present invention provides a method of implementing software components which include not only server-side metadata about callee specifications (used as an interface to offer services to higher-layer components) provided by current component architecture standards (CORBA, COM+, .NET, etc.) but also client-side metadata about caller specifications for interacting with components from lower layers.

Also, the present invention provides a method and an embodying means of automatically generating glue component templates which mediate method signature differences between caller (client) and callee (server) components independently developed by unrelated developers. The present invention also provides a method and an embodying means to assemble independently-developed components and to smoothly control message flows among them with the glue components.

Recently, with the advent of embedded systems and ubiquitous computing, a variety of application software is increasingly demanded and modifications for the software already developed are also frequently required. Therefore, software development technology is needed which allows user requirements to be easily reflected to develop required software rapidly.

However, the conventional methods of developing software, such as the structured methodology, the information engineering methodology or the object oriented methodology, etc. reach the limit in improving productivity of developing software. Accordingly, methods of component-based software development recently appeared and have rapidly spreaded, which methods are to develop software by first developing the respective software components for each functional part and then assembling them, unlike the previous methods.

That is, the information systems required by modern management become larger in their complexity and size. With more competition, rapid development of systems (time-to-market), flexible modification and extension, reduced development cost and the like are more keenly needed.

The component-based software development methodology that appeared as an optimum alternative for the need takes over the principle of divide & conquer and advantages of object-oriented development, combining unit tasks comprising a system with associated data to be software components, but making them to conform to the component architecture standards to allow them to be reused and to embody software development in the concept of assembling.

The enterprise software (large software to automate business process) is generally operated as distributed systems, and developed in a multi-layered application. The enterprise software is usually developed in a 3-tier or n-tier structure. Generally in layered design, a presentation layer is arranged on the topmost layer, a business logic layer on the intermediate layer and a data service layer on the lowest layer.

However, most of components other than those on the lowest layer are combined with a component(s) on the lower layer, and basically provide their own service to the components on the higher layer on the basis of the service of the components on the lower layer. In this case, the calling service (method) of lower-layer components is static-coded, compiled and then distributed in a form of black box-binary code.

Here, static coding is also referred to early-binding, meaning to develop client components according to and depending on the interface specification (commonly called a signature) defined in the server component. However, the component-based software development by aforementioned static coding has the technical disadvantages described as follows.

Signatures must be mutually matched among the components on the higher layer (the components calling a service, that is, a ‘client’) and those on the lower layer (those providing a service, that is, a ‘server’) in order to develop the software executing functions desired by a developer through assembling, namely reusing, the binary type components (black box form whose source codes are compiled and so concealed) already developed and available in the market. Here, a signature includes an interface to a component, such as class name (identifier), method name, a sequence of parameter types, etc.

Software unlike hardware requires various parts (that is, many components, almost countless), and their specification cannot be predetermined. In order to resolve the problem of signature matching among the components independently developed by different developers, component source codes must be modified or glue codes must be manually developed.

In addition, since the metadata provided in distribution by means of current component technology do not contain client-side information about the caller specification for interacting with components from lower layers, the detailed design information of the software system at the time of developing the components must be obtained and referred if the components to be reused rely on other components.

Furthermore, since the message flow between components is highly bound and is static-coded by means of the prior art component-based software development technology, deletion or addition of one component affects the whole system, so it is very difficult to update a part. Since messages flow is totally new in developing other software by means of assembling, such static binding conspicuously lowers the reusability of components.

In addition, the component development platform technologies (component architecture standards) currently available to software developers are CORBA, COM+, EJB, DotNet (.NET), etc. All of these platform-based components only provide the metadata about the service signature as a usage contract which they provide for the interface to client components. Therefore, it is fundamentally impossible that a binary type component can be assembled to call a method of another component other than what it was first developed to call.

That is, although it is an objective of the component-based development methodology to assemble the binary components independently developed in a form of multi-layer dependency structure, the prior art does not support it.

Because of the aforementioned reasons, software developers have mainly reused only the components for GUI (Graphic User Interface) that provide simple and independent services, and the reusability of the business logic components that are in the intermediate layer is extremely low.

That is, the components for simple GUI such as ActiveX Control, JavaBeans and the like not depending on the services of other components are mainly reused, and the components on the business layer designed and implemented by the component-based software development method are hardly reused.

In order to resolve the technical problems of the aforementioned prior art component architecture standards, some improvement methods have been proposed. One of the methods is to control the message flow among all components in the center. A representative example is to assemble components using workflow. By means of the workflow method, all components are designed as an independent component not depending on other components, and the message flow among components is controlled in the center, using workflow.

However, since a component cannot still call other components directly in the workflow method, the services (methods) of components must be designed to accept all information required in a unit task process as a parameter so as to produce the desired results independently.

Since it is not the divide & conquer and a structured method desired in software engineering, this design method is considered very unnatural and the developed components become very big, resulting in lowered generality and reusability.

Also, since, in the workflow method, all of the message flows among components are transferred by means of workflow, it causes too much overhead on networks and systems as compared to inter-component direct calling, and the entire system operation is affected when a workflow engine has some problems.

Furthermore, University of California at Irvine, USA, proposed C2 Style that is a message-based component assembling method. The method, however, has a disadvantage since the assembling process is complicated and flexible modification is not easy because the flow control logic of connecting components as well as the parameter mediation logic must be hard-coded into the wrapper code for assembling in the C2 style.

That is, the C2 style has a structure in which components are connected by connectors and messages are exchanged mutually according to a communication rule to connect (assemble) components. Communication among C2 style components is then achieved by means of transferring asynchronous service requests and notification messages. In this case, each message is broadcast to all components connected to a connector and it is determined whether to process or ignore the received messages according to the message rule defined in the wrapper code of each component.

In addition, In order to specify composition rules of components and connectors in a higher abstraction level, the C2 Style method according to the prior art defines ADL (Architecture Description Language) comprising two different notations of IDN (Component Interface Definition Notation) and ADN (Architecture Definition Notation).

Above all, in case of the C2 style according to the prior art, white box (source code modification) approach must be used, resulting in lowered reusability of components, in order to implement layered dependency among components to be reused.

### DISCLOSURE OF INVENTION

### Technical Problem

Accordingly, the present invention was proposed to solve the aforementioned problems.

It is the first objective of the present invention to provide a method of improving the reusability of components and of flexibly controlling the message flow among components without modifying a component's source-code, which are developed according to a natural component-based development method, by overcoming problems about syntactic and semantic inconsistency of signatures strictly required for inter-component binding (assembling), using the method of creating client-side metadata, mediation technology of component binding with glue codes and the method of automatically creating glue codes.

It is the second objective of the invention to provide a method of creating glue template codes to achieve assembling of components of a sequence diagram type in a top-down manner when developing software, and of implementing a multi-layered structure, in addition to the first objective of the invention.

It is the third objective of the invention to provide a method of creating and assembling components by which the reusability of components is greatly improved, providing a device and a system for and a method of developing software with components, and achieving an easy maintenance of software system as a business logic or process changes, in addition to the first and second objectives.

It is the fourth objective of the invention in addition to the aforementioned objectives to provide a device and a system for and a method of developing component-based software that allow the distributed arrangement and remote hosting of components, and the assembled components to be generally tested and monitored.

It is the fifth objective of the invention in addition to the aforementioned objectives to provide a device and a system for and a method of developing component-based software for improving the reusability of components by dividing the components in a form of proper fine grains.

It is the sixth objective of the invention in addition to the aforementioned objectives to provide a device and a system for and a method of developing component-based software, which allow binary components to be implemented in a multi-layered structure, which implement component assembly without additional work (overhead) such as broadcasting and conversion to asynchronous messages, and which do not require separate documentation in the development process and achieve cheap and quick maintenance.

### TECHNICAL SOLUTION

In order to achieve the aforementioned objectives, the invention provides a method of developing component-based software for implementing and assembling components, characterized by comprising the steps of: accepting signatures and comments of a service of a lower-layer component to be called by a component developer; creating helper function codes for dynamically binding (late binding) and calling services of glue components on the basis of the accepted signatures; creating the newly created helper function calling codes in the lower service calling portion; creating the client-side metadata to be used for selecting callee services and automatically creating the template codes of the glue components when controlling and assembling the message flow later, and creating the temporary glue components for testing and then independently testing the functions of components with said temporary glue components.

The method according to the invention for assembling components is also characterized by comprising the steps of: selecting components to be assembled and arranging them on a figure; selecting a client component and a server component among the components arranged on the figure, using a GUI tool, and then freely setting the message flow among components; automatically creating the template codes of glue components and accepting the mediation codes; and compiling the glue codes and then creating the glue components.

### ADVANTAGEOUS EFFECTS

In one aspect of the invention, it is possible to develop software in a multi-layered structure and to achieve non-procedural assembling, parallel development of software, and the like, by including the metadata containing the client-side detailed information as well as the server-side detailed interface information for interconnecting and reusing various components independently developed by different developers and having different signatures.

Also, in the method of developing component-based software according to the invention, since respective components contain client-side interface metadata, it is possible to automatically create stub component templates and also possible to substitute proper values for the templates to test component functions. Therefore, there is no problem of calling lower-layer components although developers independently develop the lower-layer components in their own way, thereby resulting in improved productivity in developing software.

A component development tool implemented according to the invention can automatically create the glue code templates for assembling components, improve the reusability of components by inserting the logic for mediating syntactic and semantic inconsistency into the parameters among the server-side and client-side heterogeneous components to be assembled, and implement a semi-automatic component assembling process. Additionally, since the invention allows a multi-layered structure assembly unlike assembling in the prior art manner, it is possible to perform the component assembly by naturally applying the original component binding relation as designed without modification.

Also, since the component-based software developed according to the invention directly connects and synchronously processes calling the methods among components, the invention reduces unnecessary system load or network load. Furthermore, since the component development tool implemented according to the invention provides an intuitive component assembly tool in a sequence diagram form to be used in analyzing system requirements and conceptually designing a system, it is possible to assemble and maintain components even more easily and cheaply without preparing the complicated and annoying ADL specification or source codes.

In addition, where the method of developing component-based software according to the invention is applied to the DotNet (.NET) development platform of Microsoft, it is easy to extend the metadata of components and to create automatically the glue code templates very efficiently, by applying the advanced technologies of CustomAttribute, Reflection, CodeDom and the like provided by Microsoft. Also, by developing an assembling tool implemented in a VSIP (Visual Studio Industry Partner) package, it is possible to provide the advanced functions such as glue code edition, source level debugging, etc., to which Visual Studio user experience is applied, and the component structure edit function in a sequence diagram form and the Intelli-sense are also applied.

In the current component distribution market, the components mainly for GUI are distributed and the kinds of components implementing business logic are not various. Also, there are only the coarse-grained business logic components with lowered generality due to the absence of layered structure-type assembling technology. On the other hand, the Active Binding Technology (calling the technology according to the present invention as Active Binding Technology hereafter) provides efficient and independent component development and testing, and also provides a client-side interface specification that allows the multi-layer assembly conforming to the original design. Therefore, the invention has an advantage to encourage the development of finer-grained and reusable components by implementing a business logic and thus to create a distribution market of the business logic components.

Also, since the Active Binding Technology according to the invention allows binary components to be assembled in a multi-layered structure, developers can match the assembly process identical to the original design and can achieve the distributed arrangement of components developed to locally operate on a network and the remote hosting for a remote operation. Accordingly, it is possible to purchase cheap binary components developed by other developers in a market and to build up a large multi-layered distributed system.

Furthermore, the editor in a sequence diagram form provided by the Active Binding Technology according to the invention finely visualizes the component assembly process in a method calling unit of time series, and enables a precise and simple assembly by generating each glue code responsible for a single method calling mediation only. Also, the editor maximizes software development productivity by automatically creating the glue code templates and providing Intelli-sense and source level-debugging functionalities.

The Active Binding Technology according to the invention can be completely integrated in the Visual Studio .NET, that is the IDE (Integrated Development Environment) of Microsoft to apply user's Visual Studio experience, so that it is possible to apply component development technology according to the invention easily and rapidly.

The Active Binding Technology according to the invention, by visualizing the detailed method-level assembly structure and by providing the appropriate metadata necessary for the assembly, may allow a 3^{rd} party developer to change a system without any additional documentation.

Therefore, a system user can save expenses for documentation and exclusive maintenance contracts, unlike conventional cases.

### BRIEF DESCRIPTION OF THE DRAWINGS

These and other features, aspects, and advantages of the present invention will become apparent through the following description, illustrated in the appended drawings. In the drawings:

FIG. 1 shows a message flow structure between components, devised to apply a method of component-based software development according to the invention;

FIGS. 2 and 3 show a prior art method of binding (assembling) components and a method of binding (assembling) them according to the invention, respectively;

FIG. 4 shows a flow chart of implementing and assembling components for developing component-based software according to the invention;

FIG. 5 shows a flow chart of an embodiment of implementing components containing client-side metadata about the caller specification for interacting with components from lower layers, according to the invention;

FIG. 6 shows a preferred embodiment of a method of assembling components according to the invention;

FIG. 7 shows a flow chart of an embodiment of a method of automatically creating glue components that mediate the message flow among components according to the invention;

FIGS. 8 to 12 show sequences of an embodiment of implementing components in a development tool provided according to the invention; and

FIGS. 13 to 25 show sequences of an embodiment of assembling components in a development tool provided according to the invention.

### BEST MODE

The invention is characterized in that a conventional concept interface is called a server-side interface and a dependency contract for lower-layer components is called a client-side interface. Also, the present invention is characterized in that it defines contents (callee metadata) about the specification required for assembling various components developed by different developers and commercially available, and the contents are contained in the client-side interface.

### MODE FOR CARRYING OUT THE INVENTION

As described, if the metadata are extended to contain client-side as well as server-side interface information, it is possible to dynamically read (that is, reflect) the metadata of components on both sides to be connected by an assembling tool and to automatically create the glue code templates.

The component assembly technology according to the invention implements a multi-layered structure of assembling binary components, and can also maximize the reusability of components by inserting the mediation logic for mediating syntactic or semantic inconsistency in parameters among heterogeneous components, into the glue codes according to the invention.

Conventionally, when developing the intermediate-layer components completing their own service depending on lower-layer components, a development sequence is required because an identifier of a lower-layer component and interface specification must be known. According to the present invention, however, a new identifier and specification is arbitrarily created to be a client-side interface, instead of using the information of lower-layer components, and the assembly tool reads the metadata and creates the glue codes having a relevant identifier and specification.

As a result, it is possible to develop and test intermediate-layer components in a non-procedural manner without lower-layer components, resulting in increased component development productivity. In the detailed description of the invention, the extended metadata and assembly method of the invention will be called the Active Binding Technology as compared to the conventional passive binding technology depending on the interface of lower-layer components.

The component assembly technology according to the invention provides the component embodiment and assembly device by smoothly controlling the message flow between components while applying a glue-mechanism—extending the existing metadata to include all the information necessary for the flexible component assembly, generating automatically the glue-template with this metadata, and enabling to develop a component independently from other components.

According to the invention, since the templates of the glue components that are the meditation components for component assembly are automatically created, the time and expense required for component assembly are remarkably reduced and the reusability of components dependent on other components is significantly improved. It is easy to develop and maintain a new system by flexibly controlling the message flow among components and mitigating the stringency in matching the inconsistency between components.

The above objectives, features and advantages of the invention will be more apparent through the following detailed description with the accompanying drawings. Hereinafter, with reference to the accompanying drawings, a preferred embodiment according to the invention will be described further in detail.

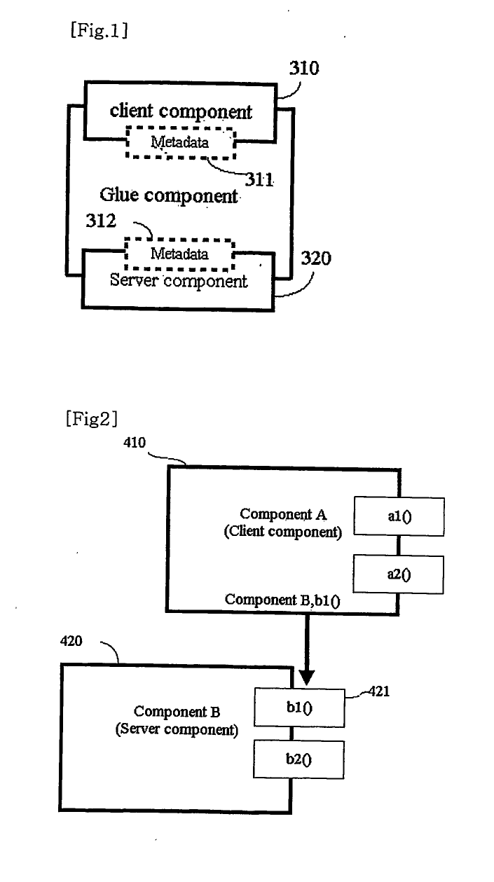

Respective drawings depict the following contents. FIG. 1 shows a message flow structure between components conceived in order to apply the method of developing component-based software according to the invention.

Referring to FIG. 1, for the flexible message flow between components 310 and 320 compiled in binary codes and provided in a black box format, the client component 310 requesting a specific function service implements a glue component 330 that is a mediator applying the glue concept, using the metadata 311 specifying with which signature a service will be used from the lower-layer component 320 (server component) and the metadata 312 corresponding to an interface that is a use contract for using the service of the server component 320, in order to assemble two components 310 and 320.

Since the glue component 330 has caller information and can dynamically control the message flow, the client component 310 and the server component 320 can call and be called each other although they do not have caller information of the other party. By means of such dynamic message flow control, efficiency in component development and assembly is improved and the projects on a component team basis can be accomplished.

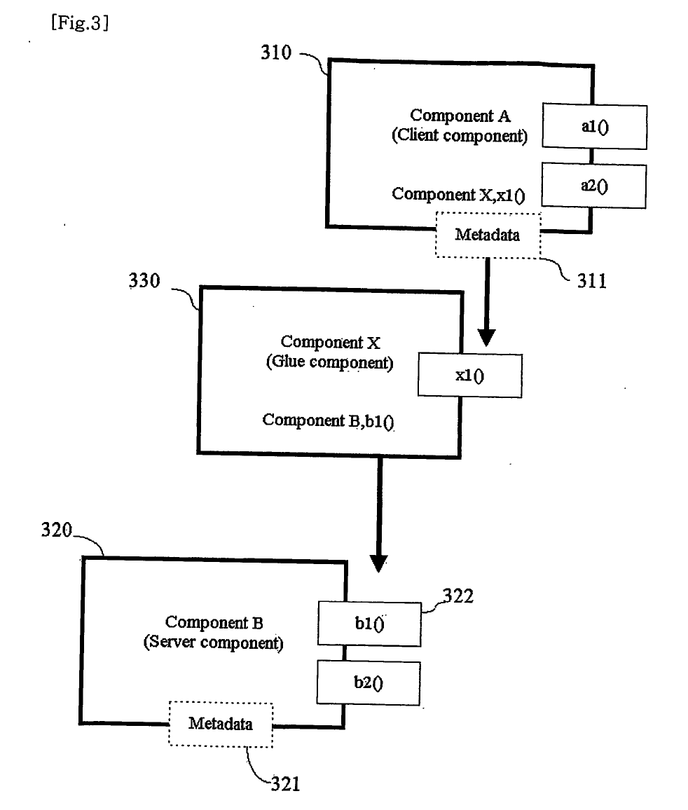

FIGS. 2 and 3 illustrate a binding method of assembling components according to the prior art and another binding method of assembling components according to the invention, respectively.

Referring to FIG. 2 (prior art), the client component A, 410, calls the service of the server component B, 420, using an interface b1( ), 421, according to the conventional method of component-based software development. The contents of calling are then static-coded and compiled in the client component A, 410, and then distributed in a binary format.

That is, since the message flow is coherently bound and static-coded, it costs very much to modify them, resulting in even lower reusability. Deletion or addition of one component greatly influences other components in the whole system. Such burden for the modification acts as an obstacle for a time-to-market in developing new products using components.

In contrast to the prior art, in the concept of component assembly according to the invention illustrated in FIG. 3, when the client component A, 310, calls the service provided through the interface b1( ), 322, of the server component B, 320, the client component A, 310, can call and use the service of the server component B, 320, although the client component A, 310, does not know the user constraints for the server component B, 320, while generating a glue component (having component identifier=component X, interface identifier=x1( ), and the operation with the same signature as the callee operation) that satisfies the attributes defined in the metadata 311, using the metadata 311 and calling the interface b1( ) of the server component B, 320, in the glue component and then transferring the result value to the client component A, 310, after creating, as metadata 311, the information defined (about component identifier=component X, interface identifier=x1( ), and operation signatures) in the part where the client component A, 310, calls the lower-layer components, and then including the metadata 311 in the components.

According to the method of assembling components according to the invention, a flexible message flow between components is achieved because components can call and be called each other although they do not know the exact caller information of the other party. By using the glue component 330, components not completely conforming to each other can be customized and connected. Since creation, modification and deletion of message flow can also be very easily performed, the load due to development and maintenance of the whole system can be remarkably reduced according to the invention.

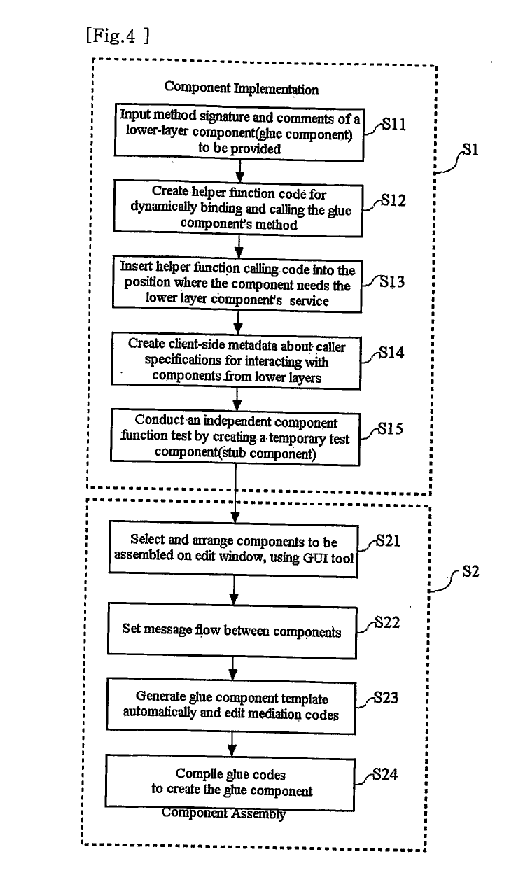

FIG. 4 depicts a flow chart for implementing and assembling components for developing component-based software according to the invention. Referring to FIG. 4, the method of developing component-based software using glue component templates according to the invention consists of steps S1 and S2 of component assembling. The step S1 of implementing components further comprises the steps of: reading in developer's input about signatures and comments of the service to be provided from a lower-layer component in order to independently implement a component having no dependency on other components with which the component will interact (S11); creating a helper function codes that dynamically bind the glue component and call the service (method) of it on the basis of accepted information (S12); inserting the helper function calling codes into the part for calling the service of a lower-layer component (S13); creating the metadata from the caller information for interacting with lower-layer components (S14); and generating the temporary glue components for testing, and then independently carrying out the component function tests (S15).

Also, the component assembly step S2 consists of following four steps of: selecting components to be assembled, using a GUI tool, and then arranging them on a figure S21; setting message flow between components arranged on the figure S22; automatically creating templates of glue components for connecting two components and then inserting a meditation code S23; and compiling glue codes and then creating glue components S24.

The invention is characterized in that it is possible to independently implement all of the components having no dependency on other components with which they will interact (in steps S11 to S13) and then to test their functions (in step S15), and in that components should have extended metadata which include information about the required service for flexible message flow control (in step S14).

Also, according to the present invention, components can be rapidly assembled while minimizing component assembling errors, by the steps of flexibly customizing component message flow in a GUI environment in S21 and S22, automatically creating templates of glue components for connecting message flow between two components while using the metadata of a caller component and a callee component in the component of assembling and editing the meditation codes for the integrity of component message flow in S23, and compiling the glue codes and thereby creating the glue components in S24.

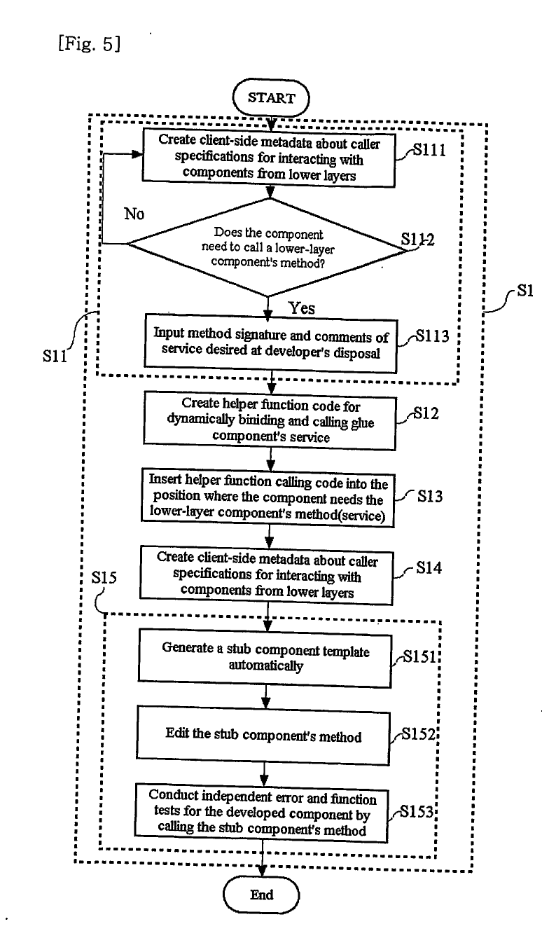

FIG. 5 shows a flow chart for illustrating an embodiment of implementing components containing the client-side metadata about the caller specification for interacting with components from lower layers, according to the invention. This process is the step of independently developing components and improving the reusability of components by processing the portion for calling lower-layer components in the components and including the information in the components as metadata when implementing the components in order to mitigate strong bonding of the message flow between components, which bonding causes fundamental problems in the conventional component-based development methods.

Referring FIG. 5 while developing components to comply with the specification according to the invention in S111, at the position where calling a service of a lower-layer component is required in S112, the signatures and comments of the service (method), for which the calling can be processed internally without the real lower-layer component, are inputted from a developer in S113.

Subsequently, on the basis of the process, a code is automatically created in S12, for defining a helper function that is a member function of the relevant class of a component which corresponds to the accepted signature, and for calling the service of the component in the helper function in a dynamic binding manner (defining the identifier for a lower-level component and its interface and calling the operation which satisfies the input signature).

Furthermore, the step S13 of automatically creating codes for substituting a newly created helper function calling for the portion of caller operations of a lower-layer component removes dependency on other components, implementing independency. If a sequence of steps for internally processing the service calling portion in components by means of the accepted signatures and comments of the service of the lower-layer components to be called is carried out using so-called Wizard, errors in the calling portion of the lower-layer components can be minimized and the processes in other steps can thus be achieved more easily.

Referring to FIG. 5 again, the component-based software development method according to the invention extends the existing metadata in S14 by creating, as metadata, the information about the caller specification for interacting with components from lower layers defined in the helper function in a component for assembling the component with a lower-layer component, and by including the information within the component. The metadata information contains the metadata about the callee specification provided by the component itself as well as the metadata about the caller specification for interacting with components from lower layers to be provided, and provides the specifications about which service the component will be provided with in assembling.

Here, the client-side metadata are created in the component, using a part of resources or DotNet (.NET) Custom Attribute, etc. in addition to the binary source codes in compiling the source codes. Since the client-side metadata extend the metadata owned by itself, it is possible to automatically create a mediator for connecting two components, using the glue mechanism in step S23.

Also, since the client-side metadata created in developing a component are used in generating a glue component template without modification, a developer does not need to create each different identifier one by one as it creates numerous glue components and identifiers of the relevant class or interface generated in the system assembly.

As a preferred embodiment of the invention, stub components are created for temporarily substituting glue components responsible for connection with the server component in order to carry out the error and function tests for components under development in step S15.

For testing each component, templates of stub components are automatically created, which have a corresponding server component identifier to be called and the interface identifier, operation signatures, etc. contained in the component, using the client-side metadata of the relevant component in step S151. A developer edits the return values of the desired service from the server component and the like in step S152, and compiles them and then calls the stub components for the independent tests of errors and functions of the developed components in step S153.

By checking the errors and functions of components by means of dynamic binding, using stub components, reflection, etc., all components can be fundamentally developed independent of other components and functional tests can be carried out for the developed components.

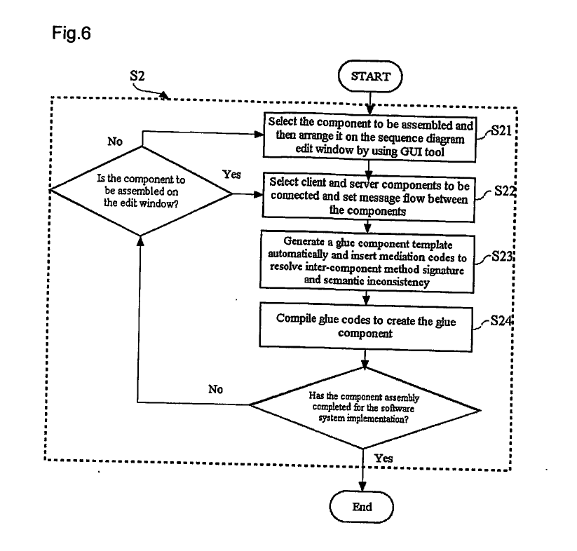

FIG. 6 illustrates a preferred embodiment of assembling components according to the invention. The component assembly process shown in FIG. 6 consists of the steps of: customizing component message flow in a graphic environment in S21 and S22; automatically creating glue component templates and editing component mediation codes in S23; and compiling glue codes and then creating glue components in S24. By repeating the steps as many times as required, a software system is obtained.

In a preferred embodiment according to the invention, each component is handled as one instruction carrying out a single function, and customizing message flow between components is applied before creating a glue component in order to smoothly arrange the execution sequence of components. Instances of components to be assembled are arranged on the figures, using a GUI tool utilizing the sequence diagram used in the system design in S21. A client component and a server component to be connected are selected among the components to set the message flow between components in S22. Use of the sequence diagram GUI tool for smoothly customizing the message flow between components has a great advantage in that it is possible to set freely the message flow that used to be dependent on component arrangement and time series.

Also, in the present invention, glue component templates are automatically created, using the client-side metadata and the metadata corresponding to the server-side component interface in order to connect two components. Mediation codes are inserted in order to resolve signature and semantic inconsistency between components in S23. Glue components are then created by compiling the glue codes in S24.

By means of such an assembly process disclosed in the invention, a large system can be assembled, using a plurality of sequence diagrams by applying a divide & conquer method, not by assembling at one time. After independently testing the functions of components respectively, it is possible to integrate them to generate an enterprise system. In the process, a component is handled as an instruction executing a single function, the execution sequence of components is smoothly arranged, and by using the sequence diagrams and glue components the whole system can be easily developed according to the invention. Therefore, a large system can be developed sophisticatedly and more rapidly.

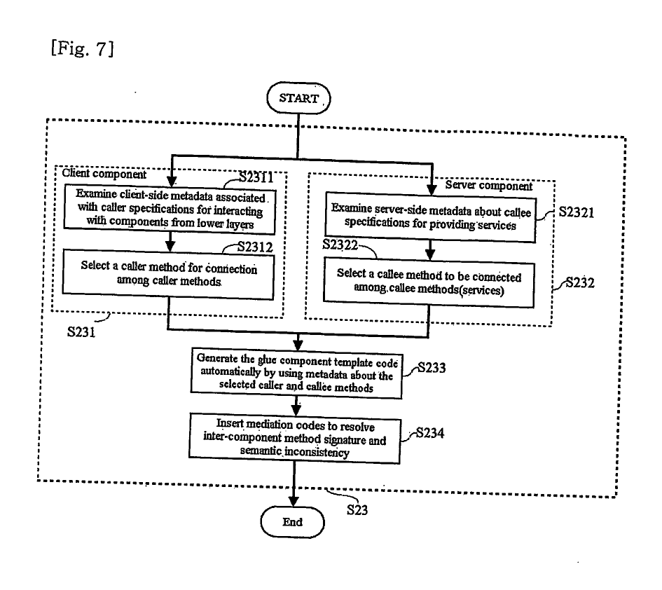

FIG. 7 shows a flow chart illustrating an embodiment of automatically creating the glue components mediating the message flow among components according to the invention. Referring to FIG. 7, metadata are examined, which data are associated with the service calling of lower-layer components of the client component, in order to interconnect the specified services between two components in S2311. The service list to be called by the client component is shown to a developer and the desired service calling is selected in S2312. Metadata corresponding to the interface of the server component are examined in S2321 to show the developer the service list provided by the server component and to allow the requested service to be selected in S2322.

Also, the template codes of glue components are automatically created, using the client-side metadata about the selected service, that is the caller specification of the client component, and the metadata of the callee specification provided by the server component in S233. In this case, the templates of the glue components are automatically created by reading the information such as a desired server component class or an interface identifier, operation signatures and the like, using the client-side metadata and then by automatically creating the source codes defining an interface with glue components, class and corresponding operation conforming to the read information.

After these processes, the developer inserts simple mediation codes into the automatically created glue component template codes to solve syntactic inconsistency of signatures and semantic inconsistency of parameters between two components and to ensure the integrity so that the two components desirably communicate with each other, in S234. As described above, insertion of client-side and server-side comments and signatures into the glue component templates makes very easy of the step of creating mediation codes by a developer. Also, system integration test can be carried out by automatically inserting the codes logging to the message contents sent/received between components when generating glue component templates, and to the time to be taken in service calling, and then by examining the logged data.

Also, in a preferred embodiment of the invention, since all tasks about component assembly and assembly tests are carried out in a GUI environment and the templates of glue components and some of source codes are automatically created, it is easy to create and modify the message flow between components without modifying their source codes. A new system can be rapidly created and easily maintained by the intuitive and simple component assembly tests that are used to be complicated and take much time.

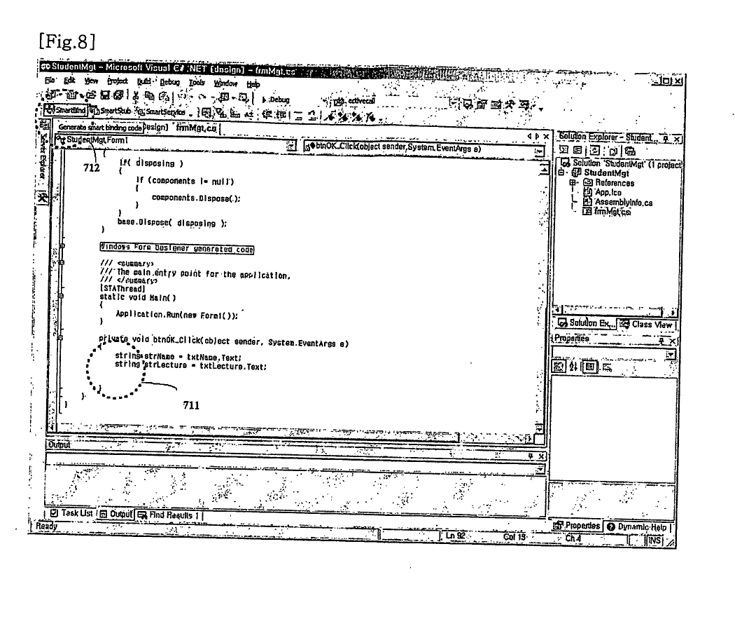

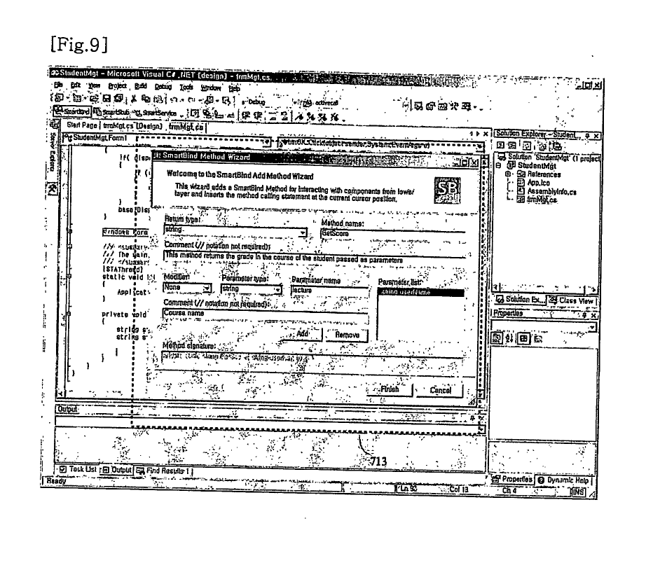

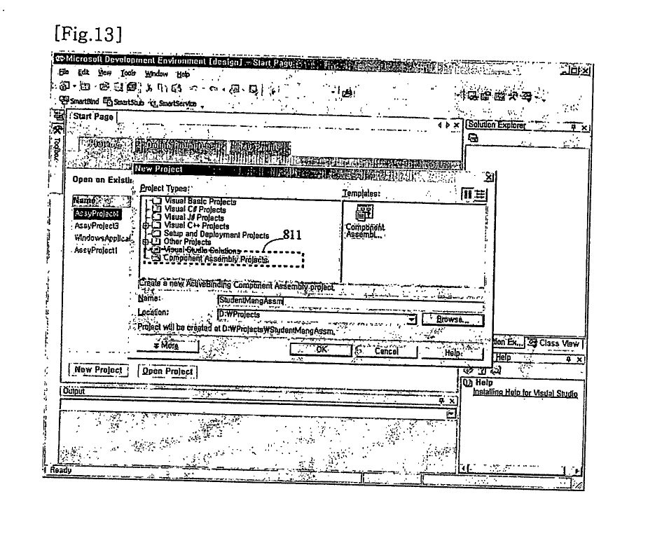

Hereinafter, referring to FIGS. 8 and 13, embodiment of the development platform providing a component-based software development environment according to the invention will be described in detail. Herein, as a preferred embodiment in FIGS. 8 to 13, the DotNet (.NET) development platform of Microsoft is described as an example, but it should be noted that the invention is not limited to the example and of course, can be extended and applied to other development platforms.

FIGS. 8 to 12 illustrate a component implementation in the GUI provided according to the invention, in a sequence. Referring to FIG. 8, when a software developer decides that a lower-layer component service is required (that is, one intends to request a method provided by a lower-layer component), while creating the codes of implementing components, one locates the ‘cursor’ on a portion where the service is required. Here, the method means a function accessible by the lower-layer component so that the higher-layer component can call it. Subsequently, the program developer clicks the menu ‘SmartBind (SmartBind, 712, client-side code and metadata creation)’ on top of the development tool.

Then, the development tool according to the invention displays the dialog box 713 for accepting identifier and a method signature to be used in calling a lower-layer component (actually a glue component).

FIG. 9 shows an embodiment of a dialog box for creating the glue component provided by the component-based software development tool according to the invention. Referring to FIG. 9, the developer enters the signature of a desired service in the dialog box 713 regardless of the signature of the service provided by the lower-layer component to be assembled later. In FIG. 9, it is shown that one enters the return type, method name, method comment, delimiter, parameter type and name, etc.

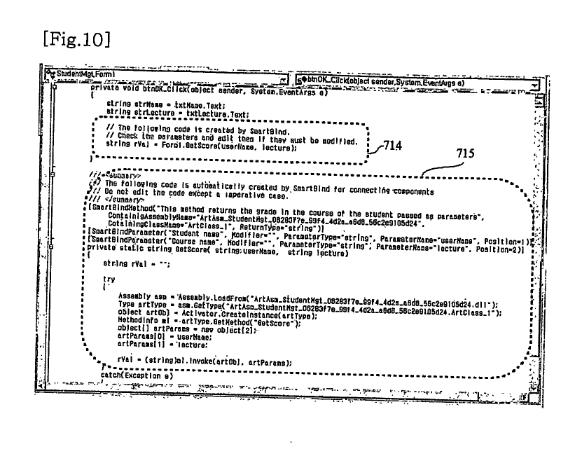

If the dialog box 713 shown in FIG. 9 is closed by clicking the “Add” button, the development tool according to the invention creates the client-side metadata for the service identifier and method signature of the service to be provided by the glue component to be generated by the assembly tool in assembling and also creates the code (denoted by 715 in FIG. 10) for creating the glue component object and calling a method, and then makes this code a function. Referring to FIG. 10, the development tool according to the invention creates a code for calling the function created on 713 in FIG. 9, on the location where the cursor was positioned on 711 in FIG. 8.

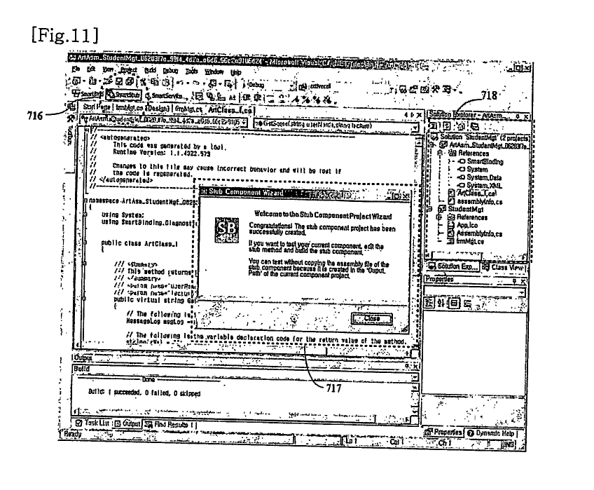

In addition, the development tool according to the invention as shown in FIG. 11 can provide a glue component creation menu button 716 for assisting the assembly with a lower-layer component in order to test whether the component under development can be assembled and operated with lower-layer components without an error.

Subsequently, when the developer clicks the menu button 716 in FIG. 11, the development tool according to the invention reads out the client-side metadata created on 715 in FIG. 10 and then creates the template codes and project files for creating a glue component with the same identifier and signatures.

The reference number 718 in FIG. 11 shows a solution search window according to the invention and project files are illustrated for generating the stub component wizard (717: a temporary glue component generated by the development tool for testing).

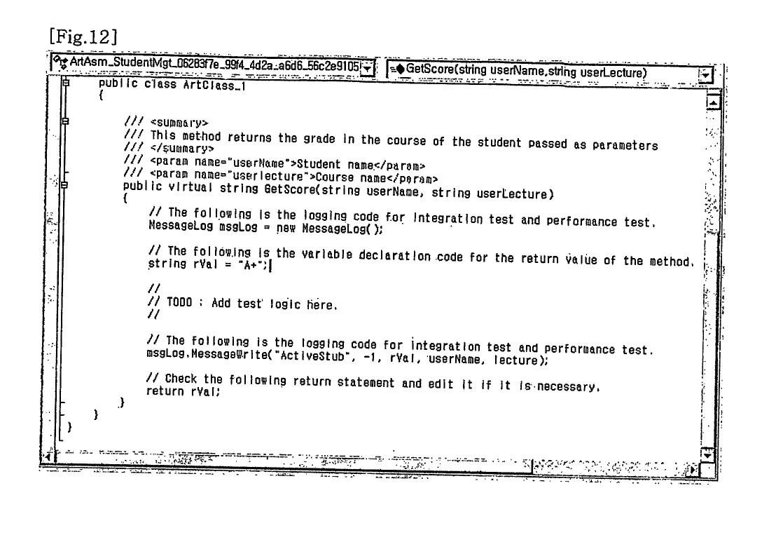

FIG. 12 shows the stub component code template created by the stub component wizard 717 in FIG. 11. The developer can then modify the code shown in FIG. 12, develop and test the components dependent on the service provided by a lower-layer component, without a lower-layer component.

The components developed and tested through the process described hereinabove in FIGS. 8 to 12 embed the server-side metadata (provided by the original component platform technology) for the service (method) provided to the higher-layer component and the client-side metadata specifying the service to be provided by the lower-layer component (actually a glue component) arbitrarily specified by the developer.

FIGS. 13 to 17 show the development tool windows of illustrating the processes of assembling components according to the invention. Referring to FIG. 13, the developer creates a new component assembly project 811 for a component assembly. That is, the developer selects a component assembly project 811 on the dialog box. Subsequently, when the dialog box is closed by clicking the “OK” button in FIG. 13, the development tool according to the invention creates files for the assembly project and displays an edit window for the component assembly 812 in a sequence diagram form.

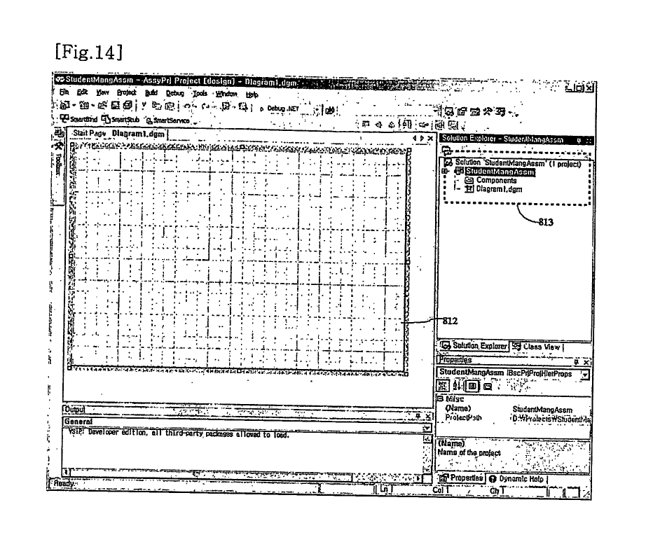

The reference number 813 in FIG. 14 shows a solution search window illustrating the project files created. The developer selects a “component” node on the solution search window 813 (for example, by pressing the right mouse button) and includes the components to be assembled in the assembly project by means of the context menu.

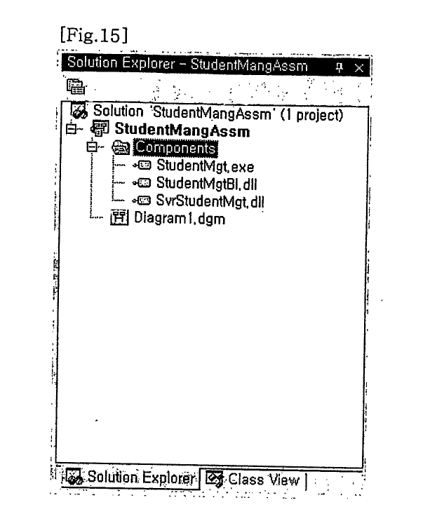

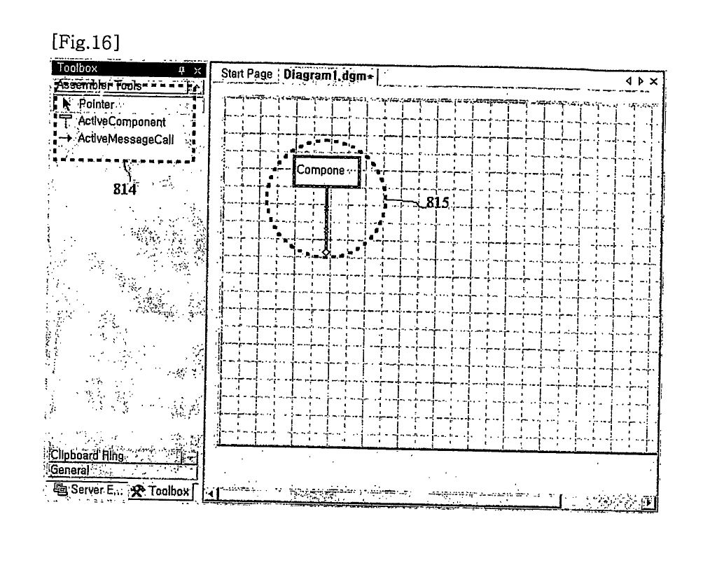

FIG. 15 shows the components included in the assembly project in the aforementioned steps of FIGS. 13 and 14. Referring to FIG. 16, the assembly tool window 814 provided to create a sequence diagram in the development tool is illustrated, where the object lifeline 815 is depicted.

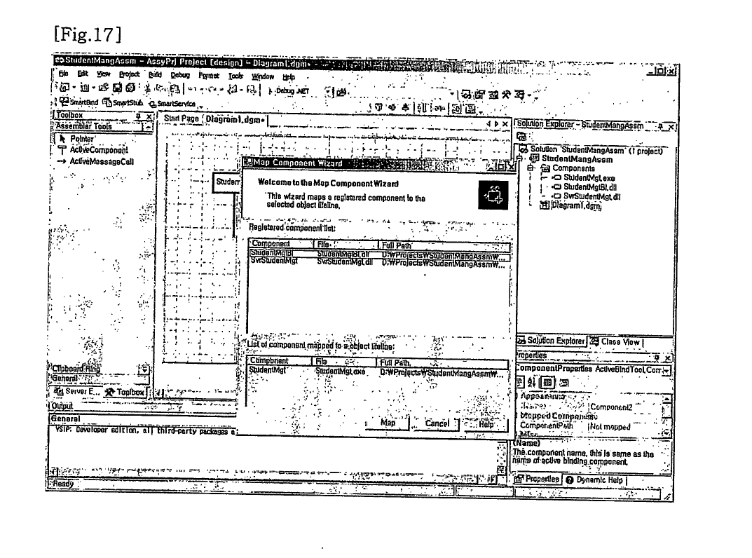

That is, when the developer drag-and-drops the component tool onto the edit window from the assembly tool window 814, the development tool displays the object lifeline in the sequence diagram. Then, as shown in FIG. 17, the developer selects one of the components included in the project, using the context menu and maps it to the object lifeline.

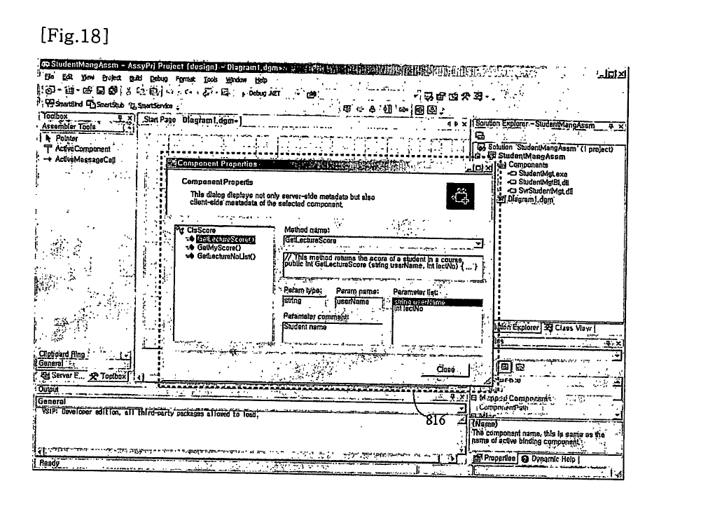

FIG. 18 shows a dialog box illustrating attributes of the object lifeline to which the relevant component matches. The development tool reads the metadata of the component mapped to the object lifeline and displays it on the attribute window 816. That is, the development tool reads the server-side component metadata and the client-side metadata and displays the signature information of each method on the attribute window 816.

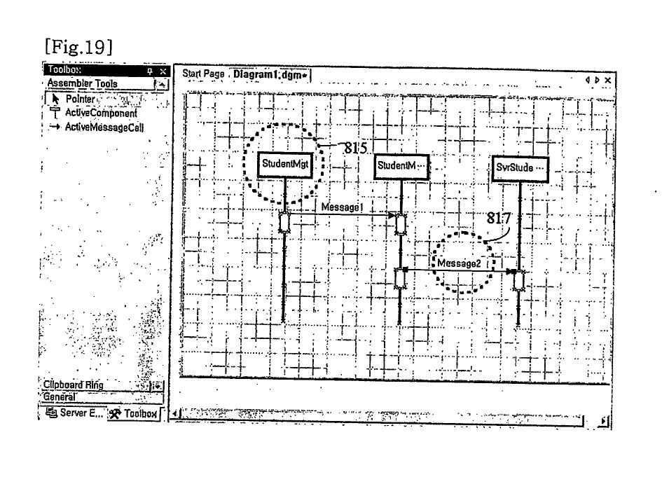

FIG. 19 shows a picture of the sequence diagram completed by the developer on the graphic edit window according to a preferred embodiment of the invention. That is, components are connected to the message 817 in order to map components to each object lifeline 815 and to indicate that the higher-layer component calls the method of a lower-layer component. According to a preferred embodiment of the invention, the message 817 in FIG. 19 is mapped to a glue component for resolving the inconsistency of identifiers and signatures between two components and connecting method calling.

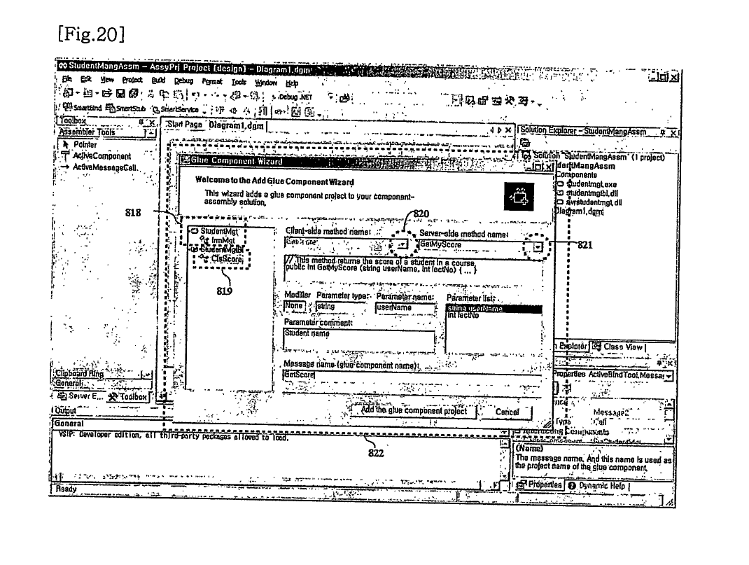

FIG. 20 shows a dialog box displaying how a developer selects messages on an editor and displays their attributes. The dialog box 822 for the message attributes in FIG. 20 shows the steps of reading out client-side metadata 818 of a higher-layer component connected to the message and then displaying the methods called by the higher-layer component, reading out the server-side metadata 819 of a lower-layer component and then displaying the service methods provided by the lower-layer component.

When the developer selects caller methods of the higher-layer component and the callee methods of the lower-layer component and then closes the dialogue box by clicking the “Add the glue component project” button, the development tool creates the codes and projects for creating the glue components for connecting the method call between two components. FIG. 20 shows a combo-box 820 for selecting the methods to be processed by a corresponding message (glue component) among the methods to be called by a higher-layer component, and a combo box 821 for selecting the methods to be processed and connected by a corresponding glue component among the callee methods of a lower-layer component.

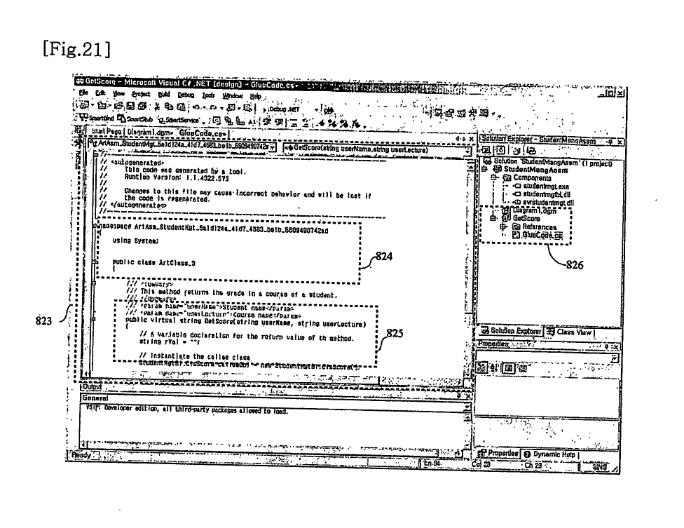

FIG. 21 shows the created project and glue code templates for creating glue components by the development tool. When the developer selects the caller methods of a higher-layer component and the callee methods of a lower-layer components and then closes the dialogue box by clicking the “Add the glue component project” button in FIG. 20, the development tool reads out the client-side metadata of the higher-layer component and then creates the glue components with the same identifier and the glue codes implementing server methods with the same signature as the caller method signature selected by the developer. Subsequently, the development tool also reads out the server-side metadata of the lower-layer component and indicates the callee method signature selected by the developer inside of the method of the glue code created in the above process as comments.

Referring to FIG. 21 again, it shows the glue codes 823 automatically created by the development tool after reading the metadata of two components, and the codes 824 of creating glue component codes with the same identifier after reading the identifier of the client-side metadata of the higher-layer component. FIG. 21 also shows the service methods 825 of the glue component having the same signature as the signature of the caller methods selected by the developer among the client-side metadata of the higher-layer component. FIG. 21 also shows a glue component project 826 created by the development tool.

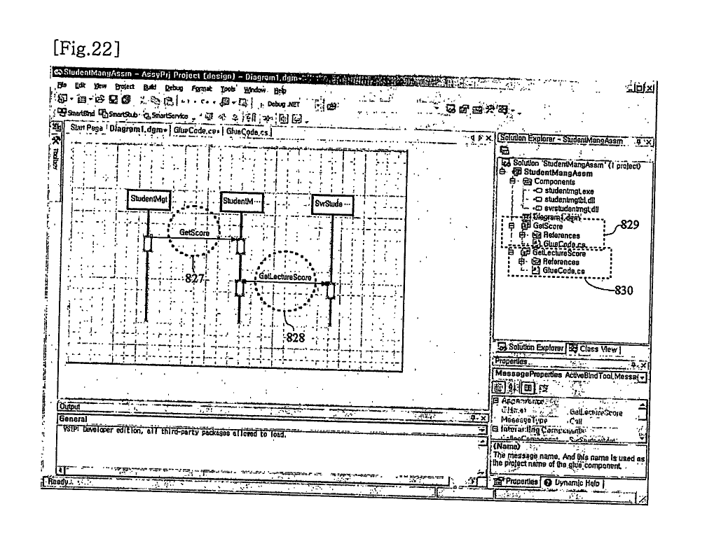

Referring to FIG. 22, it shows the glue component projects 829 and 830 shown for two messages 827 and 828, respectively, on the edit window, so that the developer can create the glue components for all messages shown on the sequence diagram.

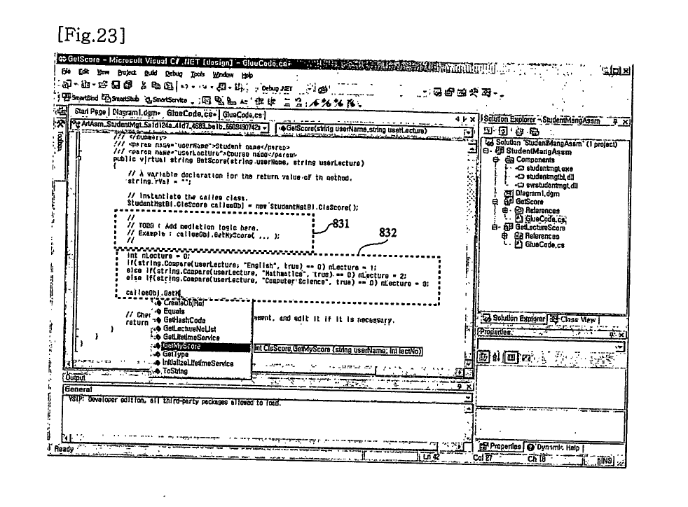

Referring to FIG. 23, the developer can edit the glue codes created by the development tool in order to resolve syntactic and semantic inconsistency of the method value signatures of two components. In FIG. 23, the development tool reads the server-side metadata of the lower-layer components and displays the signature of the callee methods as comments 831 so that the developer can easily create mediation codes.

FIG. 23 also shows an example of mediation codes 832 inserted by the developer in order to resolve signature inconsistency between two methods.

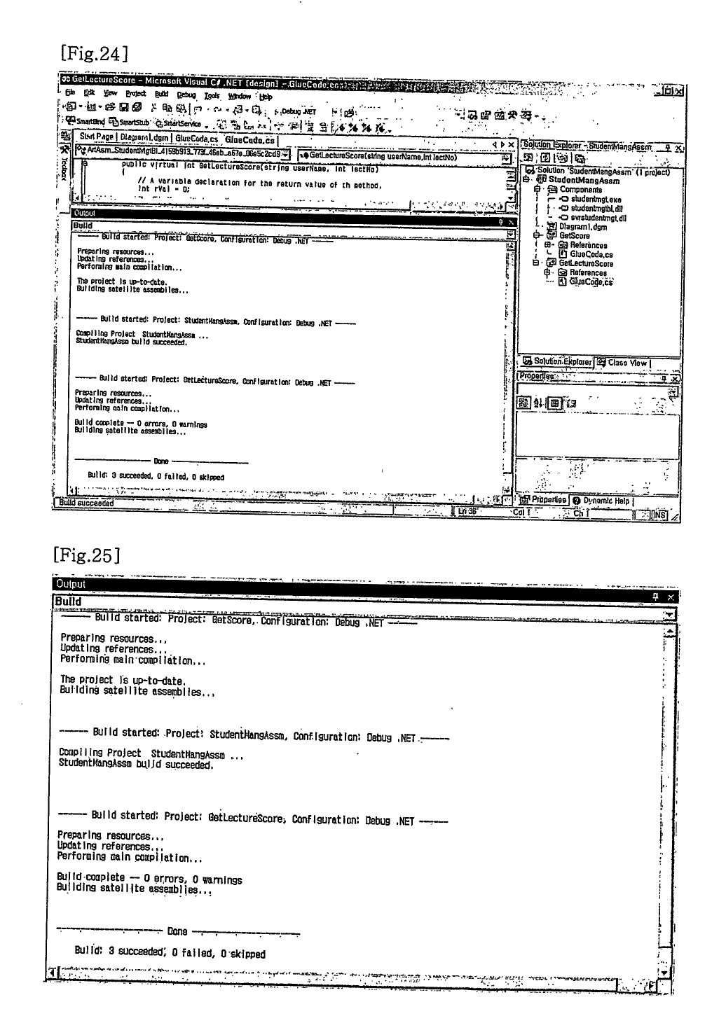

FIG. 24 shows a process that the developer clicks the ‘Build’ menu to generate a development tool, to compile the edited glue codes, and thereby to create glue components. After glue components are created through the aforementioned process, the higher-layer component calls the glue component, which in turn calls a lower-layer component.

FIG. 25 shows the result that the development tool compiles glue codes to generate glue components. After the glue components are generated through such processes, a higher-layer component calls the glue component, which in turn calls the lower-layer component.

By means of the aforementioned method, the developer does not need the detailed documentation about the source codes or the lower-layer component call in developing software independently. One can assemble and link each other very rapidly and easily the binary components (compiled) whose caller and callee method signatures do not match exactly.

The above detailed description discloses, more or less widely, the features and technical advantages of the invention in order to assist understanding the following claims even better. Additional features and advantages consisting of the claims of the invention will be detailed in the following. It should be appreciated by those skilled in the art that the concept and specific embodiments of the invention disclosed herein can be immediately used as a base of other structures or modifications for carrying out the objectives similar to those of the invention.

The inventive concept and embodiment of the invention can be used as a base for modifying the structures to or for designing another structure in order to carry out the same objectives of the invention, by those skilled in the corresponding technical field. Such modifications or modified equivalent structures by those skilled in the corresponding technical field can be changed, replaced or modified within the limit not departing from the spirit or scope of the invention stated in the following claims.

1. A method for developing software by assembling a plurality of chosen software components (called component hereafter) produced on a component-based development platform in a client-server relation,
wherein each of said components has metadata including its own identifiers and method signatures without any constraint,
wherein said metadata includes not only the callee interface information of the component as a server (called server-side metadata hereafter) but also the caller interface information of the component as a client (called client-side metadata hereafter); and
wherein the method comprises the step of creating a glue component template, using said metadata, that mediates differences between the callee specification of a server component and the caller specification of the client component to be used for calling said server component,
whereby the method enables a plurality of components that independently have arbitrary identifiers and a method signatures to be successfully assembled.

2. The method as recited in claim 1, wherein the step of creating the glue component template comprises the steps of:
(a) extracting the said client-side metadata from the client component;
(b) reading the identifiers out of the metadata of the step (a) and creating a glue component and an interface (or class) with the same identifiers;
(c) reading a method signature out of the metadata of the step (a) and creating a method with the same signature into the interface (or class) created in the step (b);
(d) extracting said server-side metadata from the server component; and
(e) creating a code for instantiating the server component and inserting the code into the method created in the step (c).

3. The method as recited in claim 2, further comprising the step of reading the method signature out of the metadata obtained in said step (d) and then inserting it as a comment into the code created in said step (e).

4. The method as recited in claim 2, wherein said step of creating a glue component template further comprises the step of creating a mediation code that compares the server component metadata with the client component metadata and resolve any syntactic/semantic differences occurring thereof.

5. The method as recited in claim 1, wherein a component containing said client-side metadata is created by the steps of:
(a) reading in developer's input about signatures and comments of the service (operation or method) to be used for calling said server (lower-layer) component;
(b) creating, with the signature information received in said step (a), helper function codes that dynamically bind a glue component and call the its method, wherein the glue component mediates service (method) call to said server component;
(c) inserting the helper function calling code of said step (b) into the part for calling the service of said server component; and
(d) creating said client-side metadata required to create glue component templates in later component assembling, and then including them in components or component resources.

6. The method as recited in claim 5, wherein said step (a) is carried out using Wizard.

7. The method as recited in claim 5, wherein said step (d), the client-side metadata are included in binary components using Custom Attributes.

8. The method as recited in claim 5, wherein said step (d), the client-side metadata are included in resources contained in or distributed together with the components.

9. The method as recited in claim 5, wherein said step (d), a glue component identifier and class or interface identifier is arbitrarily created to form the client-side metadata together with received method (operation) signatures.

10. The method as recited in claim 1, wherein after a stub component template code for testing, corresponding to a virtual server (lower-layer) component, is created using the client-side metadata contained in said component, functions of the component being developed are tested independently using the created stub component through editing and compiling.

11. A software development tool, for the component assembly within development lifecycle of component-based software development, comprising the processes of:
(a) arranging chosen components on a graphic tool window using said graphic tool;
(b) setting calling relationships among components by choosing and interconnecting client components and server components using said graphic tool;
(c) creating glue component templates and then completing the glue components by inserting mediation codes to resolve differences when the method (service) signature of said client component and that of said server component are different or semantically incongruent; and
(d) creating as many glue components as required by repeating said processes (a) to (c), whereby a plurality of glue components created in said step (d) together with said client and server components are arranged to implement a component-based software by the component assembly.

12. The tool as recited in claim 11, wherein said processes (a) and (b) are carried out to set component arrangement according to a sequence diagram and message flow according to time series.

13. The tool as recited in claim 11, wherein said processes (a) and (b) are carried out so that assembling is implemented using a plurality of sequence diagrams, each of which can be independently tested.

14. The tool as recited in claim 11, wherein said process (c) comprises the processes of:
(c1) showing a caller method (service) list of the client component to the developer for selecting one of the services;
(c2) showing a callee method (service) list provided by the server component to the developer for selecting a service to be called;
(c3) creating a template code for generating glue components, using metadata for the selected client-side and server-side method (service); and
(c4) resolving signature differences among components and semantic inconsistencies between parameters with simple mediation codes inserted into the created glue component template codes by the developer.

15. The tool as recited in claim 14, further comprising the process of examining the client-side metadata contained in a component and showing a signature and a comment list of the selected method (service) to the developer.

16. The tool as recited in claim 14, wherein said step (c3), the client-side and server-side comments and method signature are inserted into the glue component templates so that the developer can easily create mediation codes.

17. The tool as recited in claim 14, wherein said step (c3), the codes to log parameter values, return values, and elapsed time required for service calls are inserted in order for the recorded data to be used for testing.

18. A software development system, in relation to the current software development environment where the developer can produce new components upon a de facto standard component platform, comprising the processes of:
(a) reading in developer's input about identifiers and method signatures to be used for calling a lower-layer component instead of writing codes to call a method of the real lower-layer component;
(b) creating client-side metadata with the glue component identifier and the method signature read in said process (a), and then creating helper function codes that dynamically instantiate the glue component and call the its method;
(c) creating template codes and project files that generate glue components with the same identifier and signatures as the client-side metadata after reading out said metadata.

19. The system as recited in claim 18, wherein said process (c) comprises the step of automatically creating stub component templates for testing whether a component being developed can be assembled with lower-layer components and operates without errors.

20. The system as recited in claim 18, wherein the component being developed through said processes (a) to (c) contains the server-side metadata for services to be offered to higher-layer components and the client-side metadata about caller specifications arbitrarily specified by the developer to be used for calling lower-layer components.

21. A software development system, in relation to the current software development environment where the developer can produce new components upon a de facto standard component platform, comprising the processes of:
(a) creating files for an assembling project and providing an assembly editor window in a sequence diagram form when the developer creates a project for assembling components;
(b) reading out metadata of mapped components and recognizing signatures of each method when object lifelines are created on said assembly editor window and if the object lifelines are mapped to components joining the assembling project; and
(c) creating glue components when said components are connected with (UML) messages to call methods.

22. The system as recited in claim 22, further comprising the process of creating mediation codes as the developer edits the glue codes that said system generates in order to resolve syntactic/semantic inconsistencies between method signatures of the two components.
